(19) United States
(12) Patent Application Publication
(10) Pub. No.: US 2022/0343018 A1
(43) Pub. Date: Oct. 27, 2022

(54) METHOD FOR PROVIDING A PRIVACY-ENABLED SERVICE TO USERS

(71) Applicant: SafePorter LLC, Princeton, NJ (US)

(72) Inventors: Shoshana Rosenberg, Princeton, NJ (US); Jonah Perez, Portland, OR (US)

(73) Assignee: SafePorter LLC, Princeton, NJ (US)

(21) Appl. No.: 17/236,607

(22) Filed: Apr. 21, 2021

(51) Int. Cl. G06F 21/62; G06F 21/31; G06F 21/57; G06F 21/45

(52) U.S. Cl. CPC G06F 21/6254; G06F 21/31; G06F 21/577; G06F 21/45; G06F 2221/2117; G06F 2221/2141

(57) ABSTRACT

A method for providing a privacy-enabled service is disclosed. The method includes the steps of providing a client with an organization ID_{[RS1]} and generating a set of system system IDs which are assigned to the organization and associated with the client organization ID. The set of system system IDs and the organization ID are then distributed to client-designated users by the client organization system ID to permit the user to access a survey and a feedback mechanism provided by the organization. The organization is provided with information submitted by users in a de-identified aggregate, subject to certain k-anonymity controls to protect individuals who have submitted information from being identified due to changes in the aggregate via timing or scarcity of answers.

### TECHNICAL FIELD

The embodiments generally relate to computerized methods for enabling the provision of a privacy-enabled service to client-designated users and more specifically to a method for permitting client-designated users the ability to submit modify and delete information submitted to an organization and remain de-identified/unidentified to both the organization and the system receiving the information submitted.

### BACKGROUND

Organizations and individuals alike have used surveys, electronic and hard-copy forms and questionnaires to gather information related to a population. Some surveys include or allow for the disclosure of sensitive information related to personal characteristics (including, but not limited to, race, ethnicity, gender and disability) or other personal information, opinions or feedback which they may not want to be directly associated with, or that they may not want to have used in such a way as to enable or allow others to infer the identity of the user from, or in conjunction with, their responses.

Though some organizations must meet government or other requirements around the collection of specific diversity related information, many organizations have increasingly focused in the last few years on voluntarily collecting information to evaluate diversity amongst their employees, students, members, customers and communities with the intent of furthering an organizational culture which fosters or otherwise supports diversity and inclusion. In order to implement an effective initiative to increase diversity and inclusion, many organizations find it important to gather both diversity related data and feedback from users associated with the organization. While some current systems allow for information to be submitted anonymously, the information which is submitted is unable to be changed and/or deleted or accessed through a data subject access request process by the users who have provided information, and the current systems do not also protect users from being identifiable to the recipients of the information by the scarcity, timing or direct content of their answers.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a method for providing a privacy-enabled service. The method includes the steps of providing both an overarching client organization system ID to an organization and generating a set of system IDs which are assigned to the organization. The set of system IDs are then distributed to a user by the organization itself. The organization system ID is associated in the system with the set of system IDs and the organization distributes both components to a user to permit the user to access a survey and/or a survey-based feedback mechanism made accessible by or assigned by the organization. The organization is only provided information and insights based on the answers or feedback submitted by users in the de-identified aggregate. In such, the embodiments disclose a process by which a user can provide, amend, and delete information without having any direct connection to, or being identified to, the system or the organization.

The embodiments allow entities to benefit from insights and aggregated information derived from data requested from and/or allowed to be subsequently provided by designated data subjects (e.g., the users) while protecting users from being identified by or through the answers or information they submit. Where users affirmatively opt-in at the time of providing feedback or information through subsequent surveys in the system, the feedback or supplemental survey answers can be tied to the user-provided diversity-related answers to allow the organization to benefit from insights provided by the system based on multidimensional aggregated analysis.

The method provides users the ability to submit, modify, and delete answers without the requirement of a password, providing any contact information, or otherwise being identified. Data control is maintained for de-identified/unidentified users submitting information, allowing them to edit and delete their information through the system.

[symbol]

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a schematic of the system IDs generated by the system and assigned to a client, according to some embodiments;

FIG. 2 illustrates a schematic of the trust metric data and an example of the customized coding thereof, according to some embodiments;

FIG. 3A illustrates a schematic of the client assignment of the client's system IDs, according to some embodiments;

FIG. 3B illustrates a schematic of the client assignment of the client's system IDs to users which can include custom encoded trust metric data, according to some embodiments;

FIG. 4 illustrates a schematic of the process for a user accessing a website using the client organization system ID and the user's assigned client system ID, according to some embodiments;

FIG. 5 illustrates a schematic of the process for a user's first time login which prompts the user to select an image for security purposes, according to some embodiments;

FIG. 6 illustrates a schematic of the process wherein the user's assigned original client system ID is hashed, according to some embodiments;

FIG. 7 illustrates a schematic of the process wherein the added trust metric data is separated from the original client system ID and the original client system ID is hashed according to some embodiments;

FIG. 8 illustrates a schematic of the survey questions which are answered and oriented alongside the hashed original client system ID, according to some embodiments;

FIG. 9 illustrates a schematic of the process wherein the user answers questions including trust metric questions, and wherein trust metric survey questions are validated against trust metric data before being allowed to pass through to be stored with other answers, according to some embodiments;

FIG. 10 illustrates a schematic of the process wherein recipient answers are filtered through K-anonymity protocols, according to some embodiments;

FIG. 11 illustrates a schematic of the process wherein the survey recipient may return to the survey to change one or more answers or delete all information; and

FIG. 12 illustrates a block diagram of the system infrastructure and connected network, according to some embodiments.

[symbol]

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a process by which a user can provide, amend, and delete information without having any direct connection to, or being identified in any way to, the receiving organization. The embodiments allow entities to benefit from insights based on aggregated data requested from and/or allowed to be subsequently provided by designated data subjects while protecting users from being identifiable through timing or scarcity of answers/information provided. Where the user opts-in, underlying diversity related answers are tied to subsequent information provided to allow for insights to be provided to the client based on multidimensional aggregated analysis.

The system provides the ability to modify and delete answers without setting a password, providing contact information, or otherwise being identified to the system. Data control is maintained for de-identified/unidentified users submitting information, allowing them to edit and delete their information through the system.

As used herein, the term system ID describes an identifier which may include numbers, letters, symbols or combinations thereof which may be used to permit users to interact with the system.

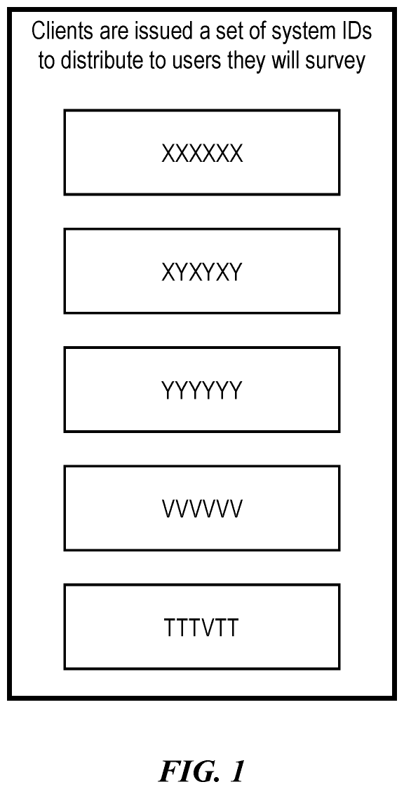

FIG. 1 illustrates a schematic to illustrate the set of system IDs which are generated by the system and assigned to the client. The set of system IDs remain associated to the client and are distributed by the client to the users they will survey. A system ID generator may be utilized to generate the system ID numbers which include set of specific number system IDs (e.g., alphanumeric, numeric, symbols, and/or alphabetic characters of a prescribed length and complexity).

In some embodiments, each user receives a unique system ID. The system IDs may remain associated with the user for as long as they remain a part of or connected to the organization unless the organization opts to sever the connection prior for any reason.

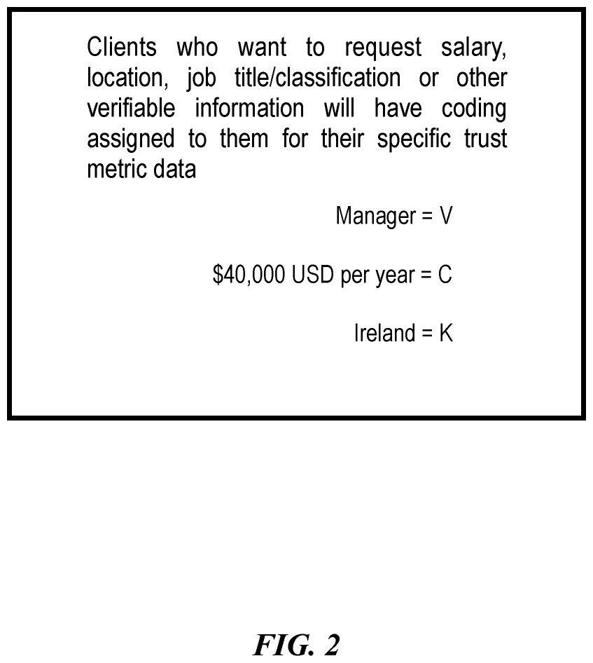

FIG. 2 illustrates a schematic of the trust metric data and an example of the customized coding thereof. The system assigns an organization system ID to the client and may also provide customized coding to trust metric data. The clients who want to request various information, such as salary information, location information, job title/classification information, or other verifiable information may receive coding assigned to them for their specific trust metric data. The organization system ID may be assigned to an organization and may be tied to the client system IDs for distribution by the organization to the users from whom they wish to request or receive information through the system.

In some embodiments, the system IDs are activated in the system by the organization, and the organization may input additional data related to the user's region, title, salary band, or other organizational-relationship verification point by a predetermined coding system. This may be called trust metric data. Unless the trust metric data is added, the system does not yet have any information or other tether to the user and “knows” only that the system ID represents one person at an organization that is known to the system. The trust metric data will not be affiliated with the hashed system ID or the users answers unless the answers provided by the user agree with and voluntarily replicate the trust metric data provided.

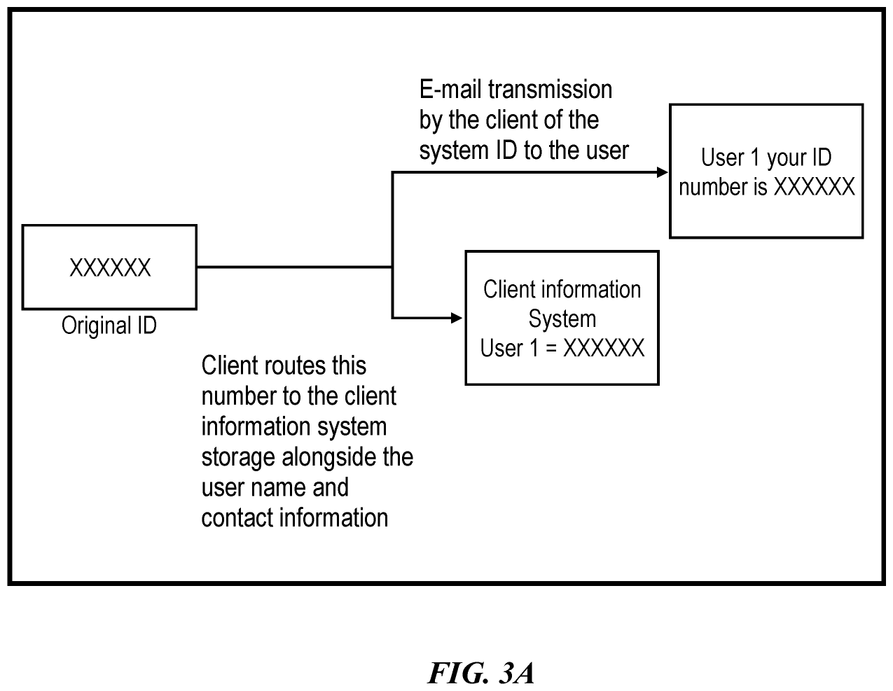

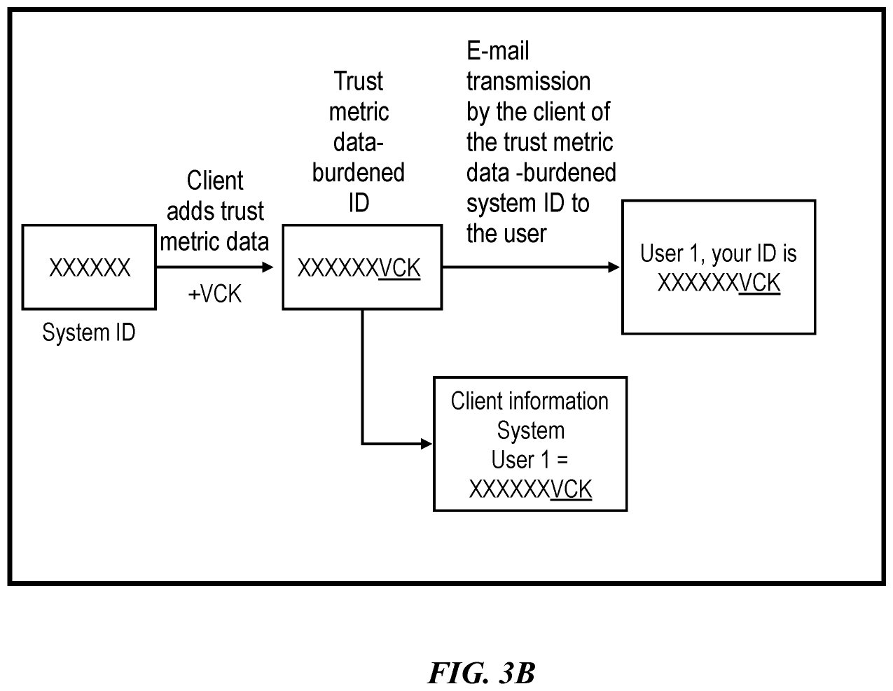

FIG. 3A illustrates a schematic of the process wherein clients are assigned a system ID without trust metric data being input. Clients may either distribute the system ID directly to survey recipients via e-mail or similar forms of communication, as well as to the client information systems to enable the user to request their system ID again from the organization. The original system ID is transmitted to the client information system. The client may route the original system ID to the client information system alongside a survey recipient name and contact information. In some embodiments, the system IDs are distributed by the organization via email (and/or the organization's ERP, or employee, member, student, customer, patient, client self-service portal) to the user they wish to survey or allow to provide information to the organization through the system solely in the de-identified aggregate.

In some embodiments, a predetermined deadline may be set by the organization for the user to interact with the system using a specific system ID, the timer begins to run against that deadline at the time of activation and the organization is notified of the system IDs that have not interacted with the system within the organization's chosen timeframe.

FIG. 3B illustrates an alternative embodiments wherein the trust metric information is input, and the system ID is distributed to the user via e-mail or similar communications means. The trust metric data is added to the original system ID to create a trust metric data-associated system ID. The client may then transmit the trust metric data-associated system ID to the client information system storage alongside the survey recipient name and contact information. The trust metric data-associated system ID is e-mailed or otherwise communicated to the user (i.e., an individual or group of survey recipients).

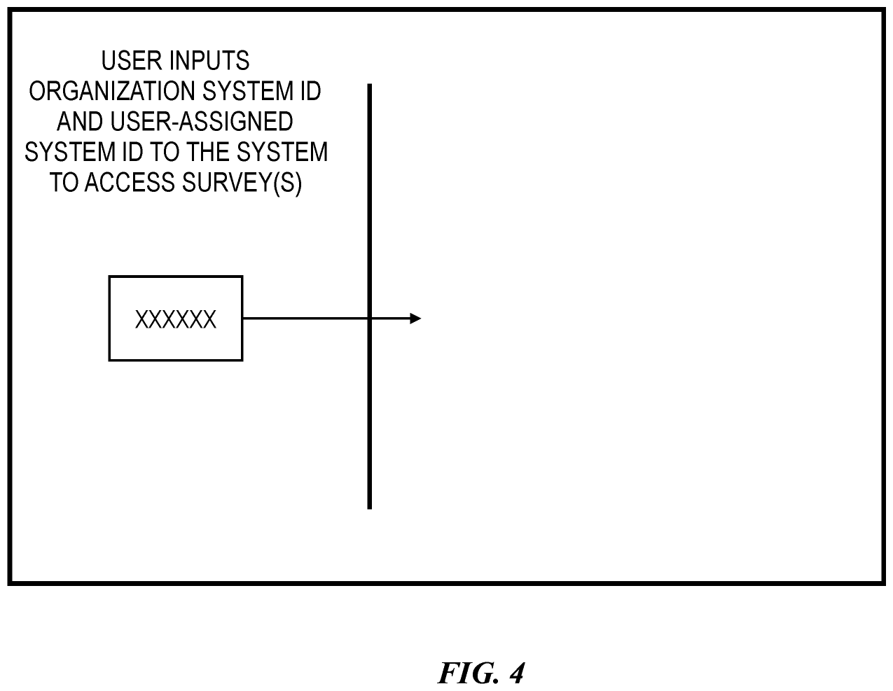

FIG. 4 illustrates a schematic of the process for the user accessing the web site and using the organization system ID and system ID assigned to them by the client. The survey recipient inputs the organization system ID and assigned system ID to the website to gain access to the survey(s). In some embodiments, the user is prompted to enter the organization ID and, upon entering the organization ID, the user is then prompted to enter the system ID.

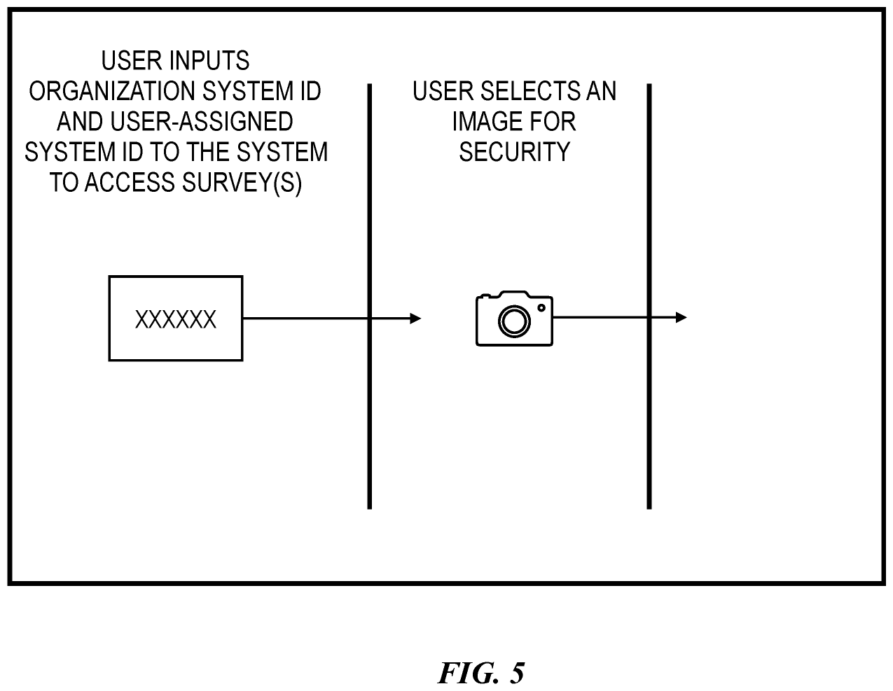

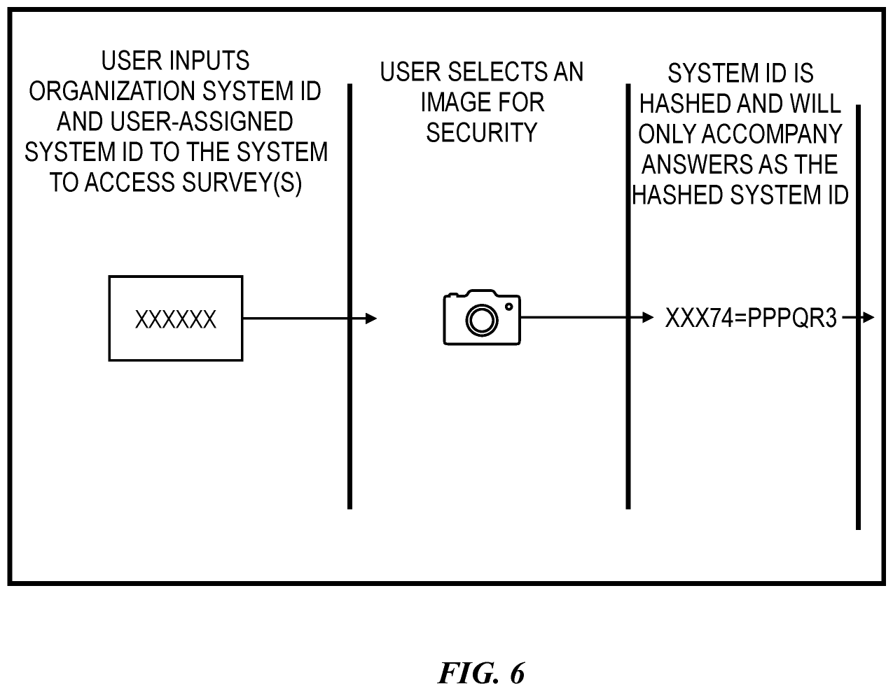

FIG. 5 illustrates a schematic of the process for a user's first time login, wherein the user is prompted to select an image. The image may be selected for security purposes. In one example, the user is prompted to select from a range of images. FIG. 6 illustrates a schematic of the process wherein the original system ID is hashed. The system ID is received by a hashing engine and the original system ID is hashed to create a hashed original system ID. The hashed original system ID may only accompany the answers to the survey questions as a hashed original system ID and the original system ID is never stored with the user answers without first being hashed.

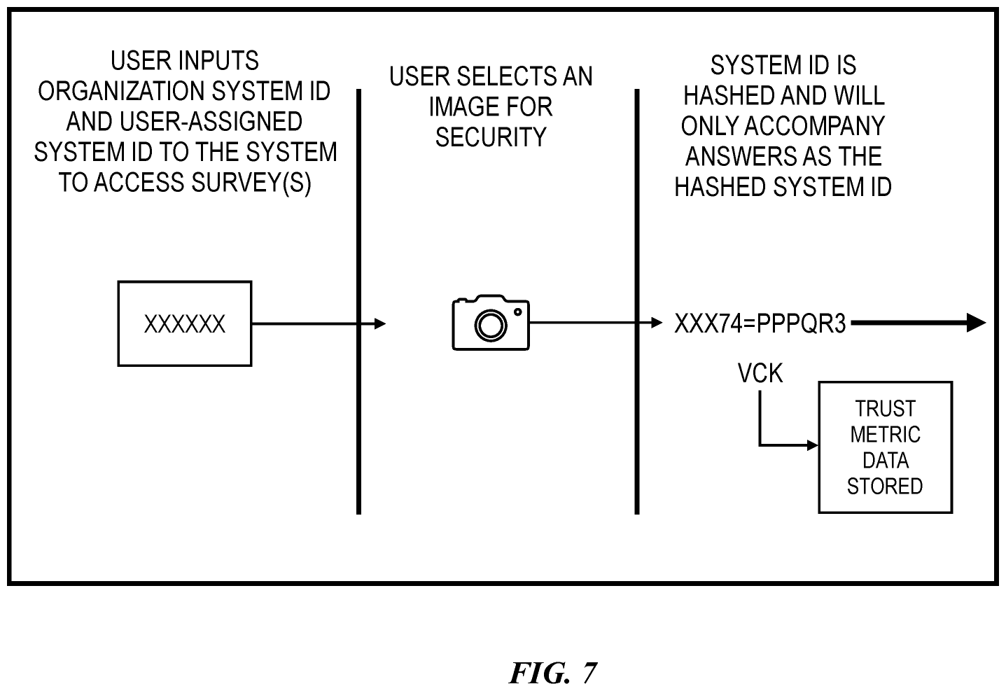

FIG. 7 illustrates a schematic of the processes wherein the trust metric data is separated from the original system ID prior to the original system ID being hashed. In such, the trust metric data (i.e., the characters which are in excess of the original system ID) is removed from the original system ID and stored in a pre-processing data quarantine that is used solely for verification purposes on the limited set of correlating trust metric data questions.

In some embodiments, when trust metric data is used, the trust metric data provided is used as a point of verification for the answers related to those items that have been provided by the organization via the following processes. Among the questions provided to the user are questions that allow them to provide the categories of information that was established by the organization in the trust metric data added to the system ID.

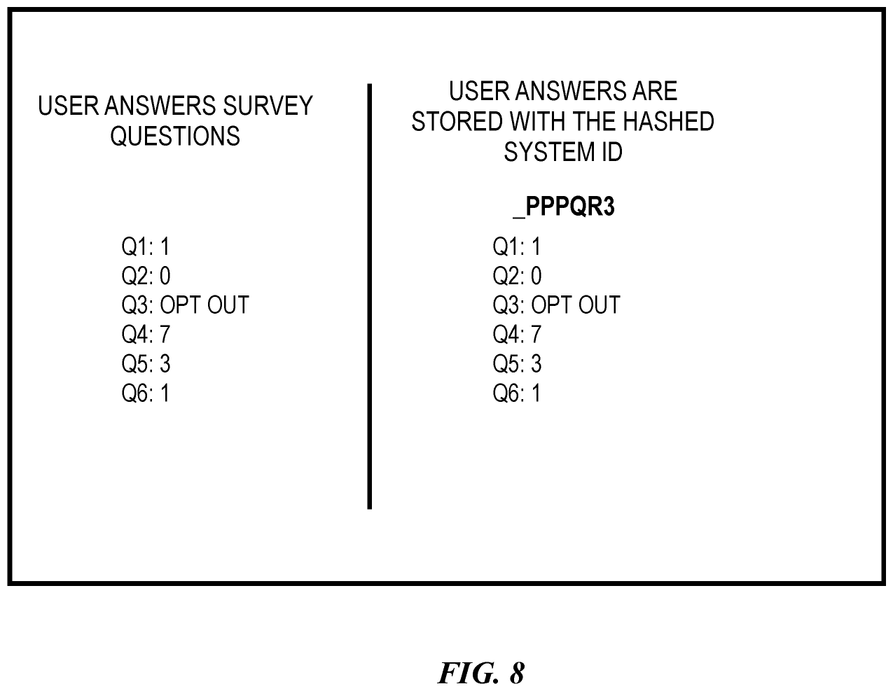

FIG. 8 illustrates a schematic of the process for storing answered survey questions which are stored alongside the hashed original system ID. First, the survey questions are answered by the user. Optionally, the user may choose to opt-out of a survey question. The answered survey questions are then stored in association with the hashed original system ID.

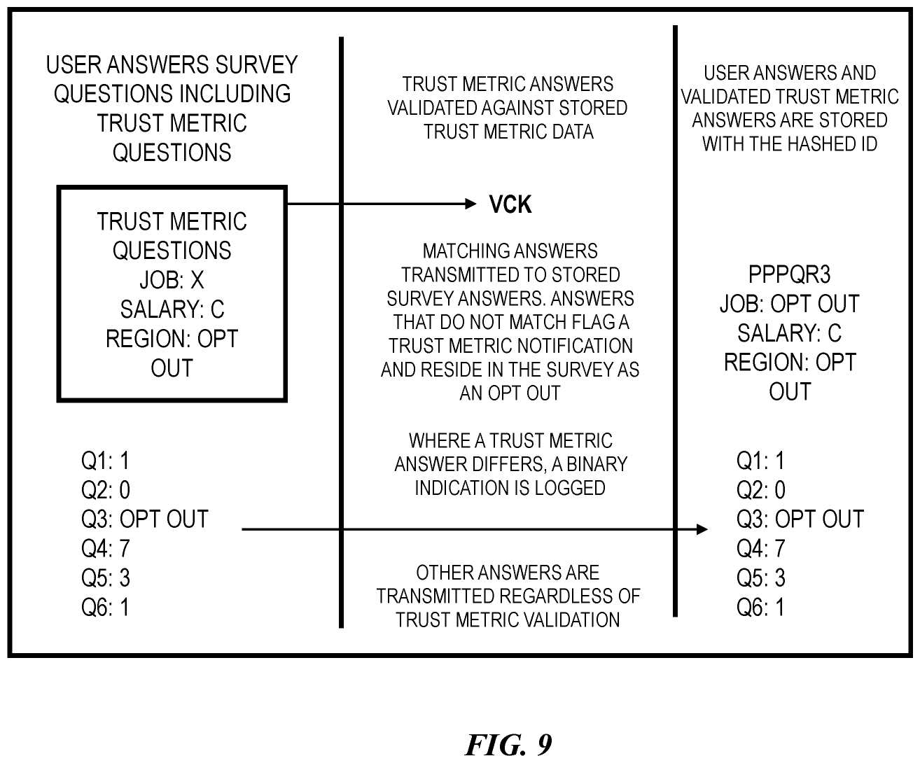

FIG. 9 illustrates a schematic of the process for validating answered survey questions against trust metric data. The user may answer the survey questions in addition to trust metric questions prompted by the system. Trust metric data answers are validated against trust metric data stored in the pre-processing data quarantine. Only matching answers pass through the stored survey answers. Answers that do not match result in a flagged trust metric data notification and is identified in the survey as an “opt-out” answer. In the event a trust metric answer differs from the provided answer, a binary indication is logged to track user distrust in the system. All answers not related to the trust metric answers are transmitted and stored with the hashed original system ID. Validated trust metric answers are also transmitted and stored with the hashed original system ID.

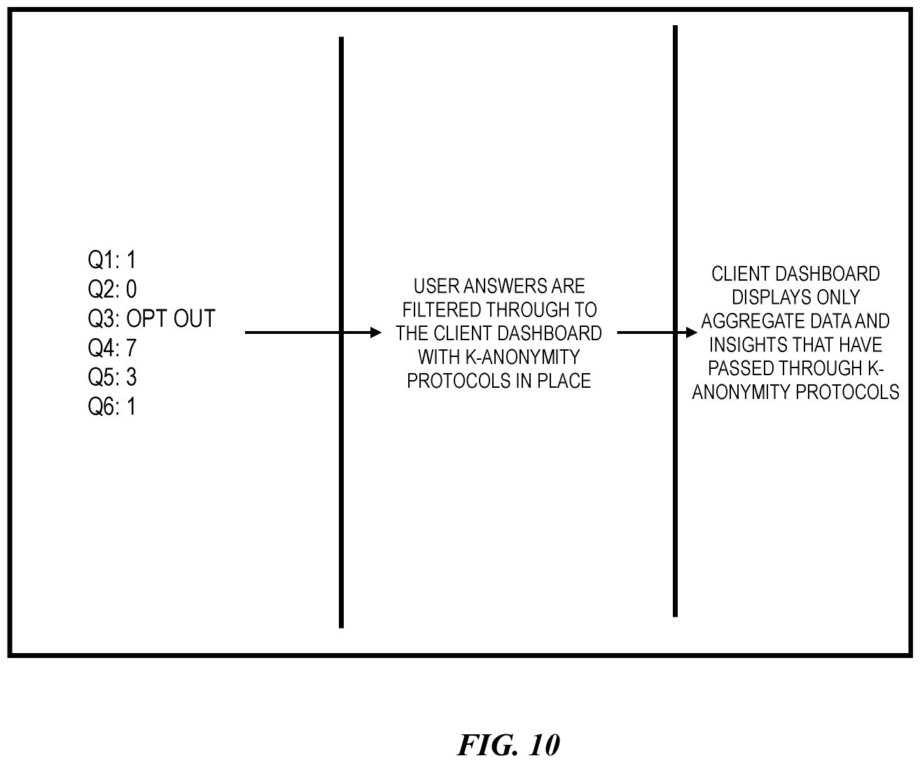

FIG. 10 illustrates a schematic of the process for filtering survey recipient answers through K-anonymity protocols. Survey answers stored in association with the hashed original system ID are filtered through to a client dashboard with K-anonymity protocols in place. The client dashboard displays only aggregate data and insights that have passed though the K-anonymity protocols.

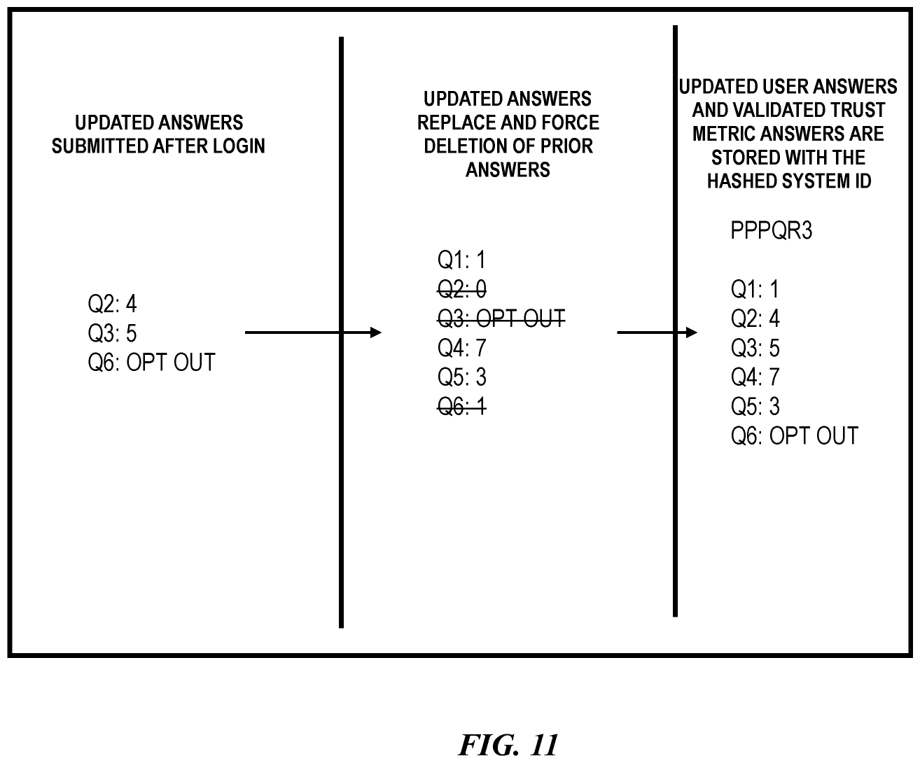

FIG. 11 illustrates a schematic of the process wherein the user can return to the system to change one or more survey answers or delete all information which was previously submitted. The updated answers are submitted by the user and replace the previously submitted answers. The updated answers along with validated trust metric answers are stored in the hashed original system ID.

In some embodiments, only user-provided data are stored in the survey/feedback databases. There is no mechanism or path by which the trust metric data provided by the organization can enter the answers/feedback database. If the user chooses not to answer any of the trust metric questions, each such opt-out is flagged in the system indicating that a trust verification point was missed, and no information comes through. If the user provides a different answer than what the organization encoded into the trust metric data on the trust metric questions, for each such mismatched answer it is flagged in the system that a trust verification point was missed, and no information is transmitted through to be stored as a user answer for that question in the system. If the user provides the same answer to the trust metric questions as exists in the trust metric data, the information provided by the user is transmitted through the system to be stored as an answer.

In some embodiments, all non-trust metric related information and verified trust metric information provided is transmitted to a geographically isolated database. Every survey access session has its own globally unique session system ID which, upon submission of the survey or session termination is deemed “used” on the back end and that token cannot be reused or reissued. User information may be provided as “write-only” which ensures that there is no possibility that the data submitted could be seen by someone returning with the system ID and organization key. The time and date of the last access/submission is logged and visible at the top of the survey to anyone using the system ID and organization ID to re-access the survey, but the answers submitted are not visible or accessible.

In some embodiments, if the user does not complete and submit an assigned survey or form for which the organization has designated a timeline, the system will provide a list of “overdue” system IDs that the organization will use to notify the corresponding users of the need to complete the assigned survey or form. No user can have access to or view the information provided previously but the user can overwrite the answers to any specific question or set of questions by providing new information/answers for any question(s). Only questions that have new answers (including the answer that opts out of providing an answer) will be overwritten when a survey is re-submitted unless the entire survey is submitted without any answers. In such, the system allows users to login to their account and edit, delete, opt-out, resubmit, or otherwise change their previously submitted answers.

In some embodiments, if the individual user has previously completed a survey to the extent required by an organization (including opt outs) and submits a blank survey or follows instructions to delete all stored information, their information will be removed from the system. Because the system does not know the identity of the user to whom any system ID is assigned, in order to engage with the system provider as a data subject and to enforce any access/portability or other data subject rights the user needs to complete a form and submit it to the organization. The organization can verify the identity of the user and that the system ID belongs to the user and submit the form to the system provider through a specific e-mail address established for data subject access requests (DSARs) related to that entity.

In some embodiments, data subjects wishing to submit information or feedback to an organization they are not affiliated with could be allowed to generate a system ID to submit information they can later edit or delete without being identified or having direct tether to the receiving entity or the survey/data input system.

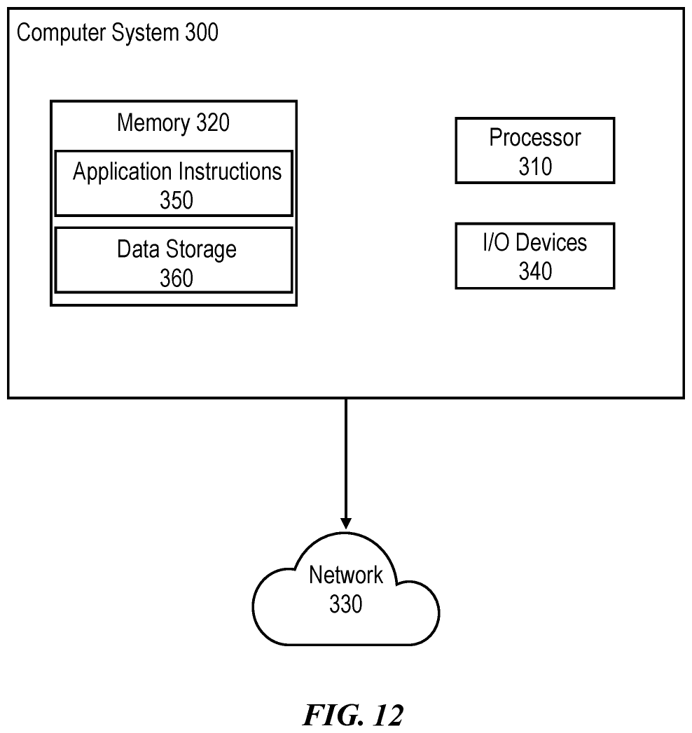

FIG. 12 illustrates a computer system 300, which may be utilized to execute the processes described herein. The computer system 300 is comprised of a standalone computer or mobile computing device, a mainframe computer system, a workstation, a network computer, a desktop computer, a laptop, or the like. The computer system 300 includes one or more processors 310 coupled to a memory 320 via an input/output (I/O) interface. Computer system 300 may further include a network interface to communicate with the network 330. One or more input/output (I/O) devices 340, such as video device(s) (e.g., a camera), audio device(s), and display(s) are in operable communication with the computer system 300. In some embodiments, similar I/O devices 340 may be separate from computer system 300 and may interact with one or more nodes of the computer system 300 through a wired or wireless connection, such as over a network interface.

Processors 310 suitable for the execution of a computer program include both general and special purpose microprocessors and any one or more processors of any digital computing device. The processor 310 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile tablet device, a mobile audio or video player, a game console, a Global Positioning System (GPS) receiver, or a portable storage device (e.g., a universal serial bus (USB) flash drive).

A network interface may be configured to allow data to be exchanged between the computer system 300 and other devices attached to a network 330, such as other computer systems, or between nodes of the computer system 300. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 320 may include application instructions 350, configured to implement certain embodiments described herein, and a database 360, comprising various data accessible by the application instructions 350. In one embodiment, the application instructions 350 may include software elements corresponding to one or more of the various embodiments described herein. For example, application instructions 350 may be implemented in various embodiments using any desired programming language, scripting language, or combination of programming languages and/or scripting languages.

The steps and actions of the computer system 300 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 310 such that the processor 310 can read information from, and write information to, the storage medium. In the alternative, the storage medium may be integrated into the processor 310. Further, in some embodiments, the processor 310 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A method for providing a privacy-enabled service, the method comprising the steps of:
providing, a client ID to an organization;
generating a set of system IDs affiliated with the client ID and assigning the set of system IDs to an organization, wherein the set of system IDs are assigned to a user by the organization and associated with that user in the organization's own systems; and
the organization providing both the organization ID and the system ID assigned by the organization to the user to permit the user to access a survey and a feedback mechanism on the system that has been assigned or made available by the organization.

2. The method of claim 1, wherein the set of system IDs are alphanumeric.

3. The method of claim 1, wherein the set of system IDs is assigned to and associated with the user by the client.

4. The method of claim 1, wherein the set of system IDs are activated by the organization before the system IDs are distributed to the user.

5. The method of claim 1, wherein the organization adds trust metric data associated with the user to the original system ID prior to distributing it to the user.

6. The method of claim 5, further comprising the step of removing the trust metric data from the set of system IDs.

7. The method of claim 6, further comprising the step of storing the trust metric data in a pre-processing data quarantine.

8. The method of claim 7, further comprising the step of logging and hashing the set of system IDs.

9. The method of claim 5, wherein the trust metric data is used as a point of verification for one or more answers provided by the user.

10. A method for providing a privacy-enabled service, the method comprising the steps of:
providing, a client ID to an organization;
generating a set of system IDs affiliated with the client ID and assigning the set of system IDs to an organization, wherein the set of system IDs are distributed to a user by the organization and associated with that user in the organization's own systems; and
assigning, via the organization, both the organization ID and the system ID to the user to permit the user to access a survey and a feedback mechanism on the system that has been assigned or made available by the organization, wherein the organization is provided information provided by the user solely in the de-identified aggregate and subject to certain k-anonymity protocols to prevent the identification of the user, wherein the user can edit, delete, or opt-out of one or more submitted survey answers.

11. The method of claim 10, wherein user-provided data or opt-out information is transmitted to a survey/feedback database tied only to the hashed original system ID.

12. The method of claim 11, wherein the set of system IDs are activated by the organization before the system IDs are distributed to the user.

13. The method of claim 12, wherein the organization enters trust metric data associated with the set of system IDs associated with the user.

14. The method of claim 13, wherein the trust metric data is unable to enter the survey/feedback database.

15. The method of claim 14, further comprising the step of removing the trust metric data from the set of system IDs.

16. The method of claim 15, further comprising the step of storing the trust metric data in a pre-processing data quarantine that does not allow the data to progress and can only interact with the remainder of the system as a point of verification for trust metric answers.

17. The method of claim 16, further comprising the step of logging and hashing the set of system IDs.

18. The method of claim 17, wherein the trust metric data is used as a point of verification for one or more answers provided by the user in response to corresponding trust metric questions.

19. The method of claim 18, further comprising the step of permitting the user to answer one or more trust metric questions established by the client organization, wherein the answer is flagged in the system as a trust metric fail if the user opts out of the answer.

20. The method of claim 19, wherein the answer is compared to the trust metric data to determine if information is valid and can be stored as an answer.
